(19) United States
(12) Patent Application Publication
(10) Pub. No.: US 2017/0168806 A1
(43) Pub. Date: Jun. 15, 2017

(54) METHOD AND ELECTRONIC DEVICE FOR MOBILE TERMINAL UPGRADE

(71) Applicants: Le Holdings (Beijing) Co., Ltd., Beijing (CN); LE SHI INTERNET INFORMATION & TECHNOLOGY CORP. BEIJING, Beijing (CN)

(72) Inventors: Liwei LIU, Beijing (CN); Fei YIN, Beijing (CN)

(21) Appl. No.: 15/250,631

(22) Filed: Aug. 29, 2016

Related U.S. Application Data
(63) Continuation of application No. PCT/CN2016/088988, filed on Jul. 6, 2016.

(30) Foreign Application Priority Data
Dec. 15, 2015 (CN) 201510940190.X

(51) Int. Cl. G06F 9/445

(52) U.S. Cl. CPC G06F 8/65

(57) ABSTRACT

Embodiments of the present disclosure are a method and an electronic device for mobile terminal upgrading. The method includes: triggering to close a CPU upon application upgrade on a mobile terminal; maintaining a desktop system and triggering to close an application icon on the desktop system during restart of the CPU; and reloading the application icon to the desktop system upon restart of the CPU.

### CROSS REFERENCE TO RELATED APPLICATIONS

This present disclosure is a continuation of International Application No. PCT/CN2016/088988, filed on Jul. 6, 2016, which is based upon and claims priority to Chinese Patent Application No. 201510940190.X, filed on Dec. 15, 2015, the entire contents of which are incorporated herein by reference.

### TECHNICAL FIELD

The disclosure relates to the technical field of mobile terminals, and more particularly, to a method and an electronic device for mobile terminal upgrading.

### BACKGROUND

In recent years, with the dramatic development of the mobile communication technologies, and the advancement of smart orientation of the mobile terminals, people are entering a new mobile Internet era. Emergence of various mobile terminals having the network connection capability, such as, mobile phones, tablet computers, electronic books and the like, brings great convenience to people to access the Internet anytime and anywhere. Development of Android even pushes the mobile terminals to an era dominated by applications and data. today's mobile terminal platforms have various functions such as office, entertainment, social networking and the like, and data stored thereon are more diversified, for example, pictures, music, videos, cartoons and the like.

Various applications may be installed on a mobile terminal. To optimize the applications, generally the applications need to be upgraded. For example, bugs would greatly affect user experience, and thus the developer, in the advent of problems, always desires to find a solution, integrate other updated application versions and ensure that users to initially use this application download the latest version, and meanwhile desires users who have installed this application to update the application timely, to prevent attacks due to the hugs. In addition to the bugs, there are a lot of buttons, deployments, interaction manners and the like which may affect the user experience. Generally, before release of a latest version, these factors are considered, and then discussions are made on determining which aspects need to be modified or cannot be modified, to reach an optional effect of the latest version.

The application needs to be upgraded if an update is available. Using a mobile phone using the Android system as an example, a version identifier is defined in AndroidManifest.xml for each Android APK, wherein two fields of android: version Code and android: version Name respectively denote version code and version name. version Code is an integer number and version Number is a character string. Since the versions are for the user to check, it is hard to compare the sizes of the versions. During update checking, the version Code is mainly checked, which is convenient for comparing the sizes of the version before and after upgrade.

APK is an abbreviation of Android Package, that is, an Android installation package. The APK is of a file format similar to Symbian Sis or Sisx. The APK file may be installed after the APK file is directly transferred to an Android simulator or an Android mobile phone. The APK file is the same as sis, and the project of android sdk compilation is packaged as an installation program file, in the format of APK. The APK file is actually in a zip format, with the suffix being modified to APK. By means of upzipping, a Dex file may be found. Dex is an abbreviation of DalvikVM executes, that is, an Android Dalvik execution program, which is a Dalvik byte code instead of a Java Me byte code. When a program is to be run on the Android system, firstly the program needs to be unzipped, and then similar to Symbian, is different from the PE file in Windows Mobile.

As illustrated in FIG. 1, using a mobile phone using the Android system as an example, the flowchart of updating an application program on the mobile phone includes:

placing the APK in the latest version on a server, and configuring a version information calling interface or file corresponding to the APK on the sever;

performing version reading and checking on a client of the mobile terminal to compare the versions on the server and client;

downloading the APK file in the latest version; and

installing the APK file in the latest version.

Upon upgrade of an application, the mobile terminal needs to be restarted. This is because: generally each time the mobile terminal is started, many programs are running, and maintaining the running of the programs in the current default mode is favorable to stability of the system. However, some updates would change some default states. If a program is currently being used, errors may be caused once the default state of the program is forcibly changed. In addition, for the purpose of security; changing the default state of the system is generally considered as an action of the virus, and if the default state is forcibly changed, the system would be unstable.

However, in the related art, upon upgrade of the application, restart of the mobile terminal will cause users to wait the restart, and thus user experience is affected.

### SUMMARY

The present disclosure provides a method and an electronic device for mobile terminal upgrading, which are capable of preventing visual waiting due to restart of an application upon update of the application.

An embodiment of the present disclosure provides a method for mobile terminal upgrading, including:

triggering to close a CPU upon application upgrade on a mobile terminal;

maintaining a desktop system and triggering to close an application icon on the desktop system during restart of the CPU; and

reloading the application icon to the desktop system upon restart of the CPU.

An embodiment of the present disclosure further provides an electronic device, including at least one processor; and a memory communicably connected with the at least one processor for storing instructions executable by the at least one processor, wherein execution of the instructions by the at least one processor causes the at least one processor to:

trigger to close a CPU upon application upgrade on a mobile terminal;

maintain a desktop system and trigger to close an application icon on the desktop system during restart of the CPU; and

reload the application icon to the desktop system upon restart of the CPU.

An embodiment of the present disclosure further provides a non-transitory computer-readable storage medium storing executable instructions that, when executed by an electronic device with a touch-sensitive display, cause the electronic device to:

trigger to close a CPU upon application upgrade on a mobile terminal;

maintain a desktop system and triggering to close an application icon on the desktop system during restart of the CPU; and

reload the application icon to the desktop system upon restart of the CPU.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating update of an application in the related art;

FIG. 2 is a schematic flowchart illustrating a method for mobile terminal upgrading according to a specific embodiment of the present disclosure;

FIG. 3 is a detailed schematic flowchart illustrating a method for mobile terminal upgrading according to a specific embodiment of the present disclosure;

FIG. 4 is a schematic structural diagram of a mobile terminal according to a specific embodiment of the present disclosure; and

FIG. 5 is a schematic structural diagram illustrating a mobile terminal according to the present disclosure.

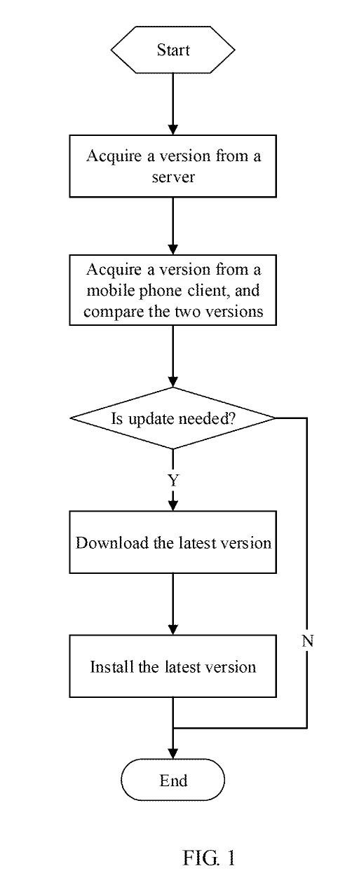

### DETAILED DESCRIPTION

To make the objectives, technical solutions and advantages of the embodiments of the present disclosure clearer, the technical solutions according to the embodiments of the present disclosure are clearly and thoroughly described with reference to the accompanying drawings of the embodiments of the present disclosure. The described embodiments are merely exemplary ones, but are not all the embodiments of the present disclosure. Based on the embodiments of the present disclosure, all other embodiments derived by persons of ordinary skill in the art without any creative efforts shall fall within the protection scope of the present disclosure.

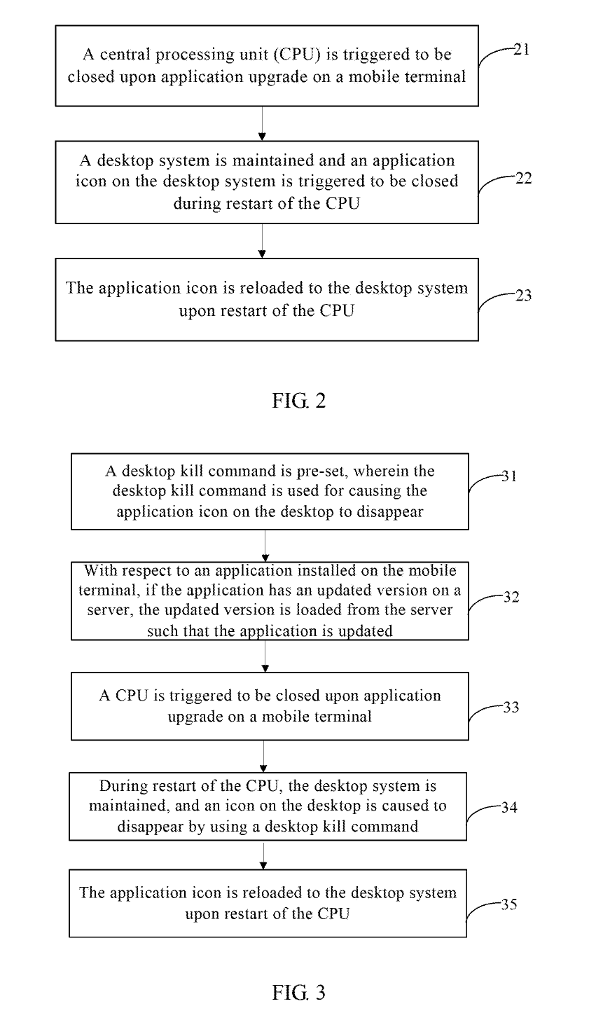

FIG. 2 is a schematic flowchart illustrating a method for mobile terminal upgrading according to a specific embodiment of the present disclosure.

As illustrated in FIG. 2, the method includes the following steps:

In step S21: A central processing unit (CPU) is triggered to be closed upon application upgrade on a mobile terminal.

In step S22: A desktop system is maintained and an application icon on the desktop system is triggered to be closed during restart of the CPU.

In step S23: The application icon is reloaded to the desktop system upon restart of the CPU.

With the method for mobile terminal upgrading according to this embodiment of the present disclosure, upon application update on a mobile terminal, only the CUP of the mobile terminal needs to be closed, with no need to close the desktop system; and during restart of the CPU, the application icon on the desktop system is triggered for shutoff, and upon restart of the CPU, the application is reloaded to the desktop system. For the user, during the entire restart process, the icon on the desktop is only absent for a small period of time. In this way, no visual waiting due to restart of an application upon update of the application is caused to the user.

### Embodiment 2

FIG. 3 is a detailed schematic flowchart illustrating a method for mobile terminal upgrading according to a specific embodiment of the present disclosure.

As illustrated in FIG. 3 the method includes the following steps:

In step S31: A desktop kill command is pre-set, wherein the desktop kill command is used for causing the application icon on the desktop to disappear.

In this step, the desktop kill command is to open any APK on the desktop system, or to open a designated APK on the desktop system. A user may cause the application icon on the desktop to disappear by opening any APK or a designated APK on the desktop system of the mobile terminal.

In step S32: With respect to an application installed on the mobile terminal, if the application has an updated version on a server, the updated version is loaded from the server such that the application is updated.

In this step, an APK file in the latest version is placed on the server, and a version information calling interface or file corresponding to the APK is configured on the sever: version reading and checking are performed on a client of the mobile terminal to compare the versions on the server and client; and if the version on the sever is updated against the version on the client, the APK file in the latest version is downloaded to update the application.

In step S33: A CPU is triggered to be closed upon application upgrade on a mobile

Downloading an update and installing an update are two different activities. Restart is the basis of installing the update, and for some updates, the entire installation process may be completed only upon restart, and if restart is performed, installation of the application update to be restarted is completed. Under this circumstance, the client that has been updated but has not be restarted stays in an intermediate state, which is neither completely updated, nor in the state before the update. In such an intermediate state, some files may have been overwritten, added or updated, or may be in a locked or protected state due to other circumstances. With respect to the update requiring restart, before restart, bugs to be rectified by the update are still present, and as a result, these files fail to be protected.

In this step, if restart is required after the application is updated, the CPU only needs to be triggered to shutoff, but the desktop system does not need to be closed. For the user, no visual waiting due to restart of an application upon update of the application is caused.

In step S34: During restart of the CPU, the desktop system is maintained, and an icon on the desktop is caused to disappear by using a desktop kill command.

In this step, during restart of the mobile terminal, the CPU only needs to be closed and then restarted, and the desktop system does not need to be closed. Instead, the icon on the desktop is caused to disappear by opening any APK or a designated APK on the desktop system of the mobile terminal. For the user, no visual waiting due to restart of an application upon update of the application is caused.

In step S35: The application icon is reloaded to the desktop system upon restart of the CPU.

In this step, upon restart of the CPU, the application icon is reloaded to the desktop system. For the user, during the entire restart process, the desktop is still visible, but the icon on the desktop are absent for a period of time.

With the method for mobile terminal upgrading according to this embodiment of the present disclosure, a desktop kill command for causing an icon on the desktop to disappear is predefined, and upon application update on a mobile terminal, the CUP of the mobile terminal only needs to be closed, with no need to close the desktop system; and during restart of the CPU, the application icon on the desktop system is triggered for shutoff, and upon restart of the CPU, the application is reloaded to the desktop system. For the user, during the entire restart process, the icon on the desktop is only absent for a small period of time, and the mobile terminal would not be absolutely turned off. In this way, no visual waiting due to restart of an application upon update of the application is caused to the user.

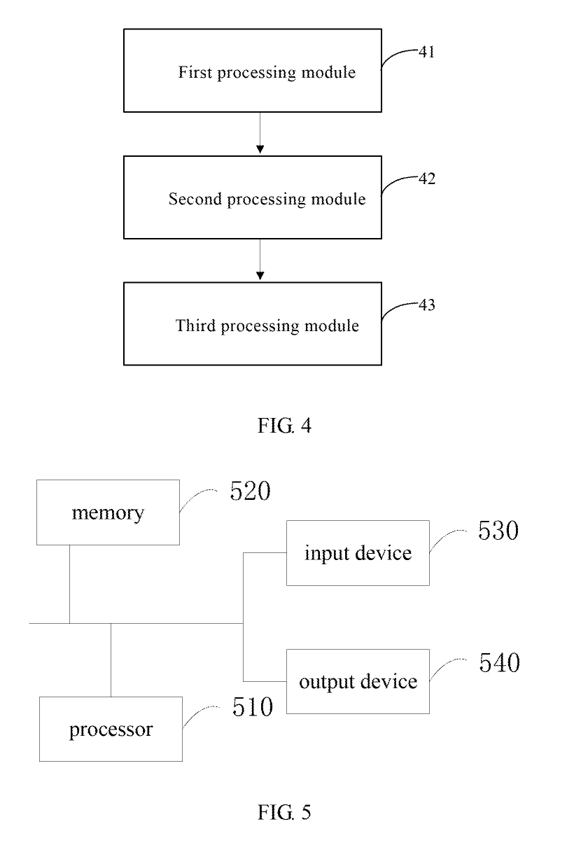

FIG. 4 is a schematic structural diagram of a mobile terminal according to a specific embodiment of the present disclosure.

As illustrated in FIG. 4, the mobile terminal according to the present disclosure includes:

a first processing module 41, configured to trigger to close a CPU upon application upgrade on a mobile terminal;

a second processing module 42, configured to maintain a desktop system and trigger to close an application icon on the desktop system during restart of the CPU; and

a third processing module 43, configured to reload the application icon to the desktop system upon restart of the CPU.

The mobile terminal according to the present disclosure further includes:

a fourth processing module (not illustrated in the drawings), configured to pre-set a desktop kill command, the desktop kill command being used for causing the application icon on the desktop system to disappear.

The desktop kill command is to open any APK on the desktop system. The user may cause the application icon on the desktop to disappear by opening any APK or a designated APK on the desktop system of the mobile terminal.

The specific technical details involved in the mobile terminal according to the present disclosure are similar to those in the method for mobile terminal upgrading as described above, which are thus not described herein any further.

The mobile terminal according to this embodiment of the present disclosure, a desktop kill command for causing an icon on the desktop to disappear is predefined, and upon application update on a mobile terminal, the CUP of the mobile terminal only needs to be closed, with no need to close the desktop system; and during restart of the CPU, the application icon on the desktop system is triggered for shutoff, and upon restart of the CPU, the application is reloaded to the desktop system. For the user, during the entire restart process, the icon on the desktop is only absent for a small period of time, the mobile terminal would not be absolutely turned off. In this way, no visual waiting due to restart of an application upon update of the application is caused to the user.

Embodiments of the present disclosure further provide a non-volatile computer-readable storage medium, the non-volatile computer-readable storage medium is stored with computer executable instructions which are configured to perform any of the embodiments described above of the method for mobile terminal upgrading.

FIG. 5 is a schematic structural diagram illustrating a mobile terminal according to the present disclosure , as shown in FIG. 5, the device includes:

One or more processors 510 and a memory 520, FIG. 5 illustrates one processor 510 as an example.

The device for the method for mobile terminal upgrading may further include an input device 530 and an output device 540.

The processor 510, the memory 520, the input device 530 and the output device 540 may be connected with each other through bus or other forms of connections. FIG. 5 illustrates bus connection as an example.

As a non-volatile computer-readable storage medium, the memory 520 may be configured to store non-volatile software program, non-volatile computer executable program and modules, such as program instructions/modules corresponding to the method for mobile terminal upgrading according to the embodiments of the disclosure (for example, the first processing module 41, the second processing module 42, and the third processing module 43, as illustrated in FIG. 4). By executing the non-volatile software program, instructions and modules stored in the memory 520, the processor 510 may perform various functional applications of the server and data processing, that is, the method for mobile terminal upgrading according to the above mentioned embodiments.

The memory 520 may include a program storage area and a data storage area, wherein, the program storage area may be stored with the operating system and applications which are needed by at least one functions, and the data storage area may be stored with data which is created according to use of the device for mobile terminal upgrading. Further, the memory 520 may include a high-speed random access memory, and may further include non-volatile memory, such as at least one of disk memory device, flash memory device or other types of non-volatile solid state memory device. In some embodiments, optionally, the memory 520 may include memory provided remotely from the processor 510, and such remote memory may be connected with the device for mobile terminal upgrading through network connections, the examples of the network connections may include but not limited to internet, intranet, LAN (Local Area Network), mobile communication network or combinations thereof.

The input device 530 may receive inputted number or character information, and generate key signal input related to the user settings and functional control of the device for mobile terminal upgrading. The output device 540 may include a display device such as a display screen.

The above one or more modules may be stored in the memory 520, when these modules are executed by the one or more processors 510, the method for mobile terminal upgrading according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) mobile communication device, characterized in having a function of mobile communication mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID and UMPC devices, such as iPad;

(3) portable entertainment device, which can display and play multimedia contents, and includes audio or video player (such as iPod), portable game console , E-book and smarttoys and portable vehicle navigation device;

(4) server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof Such modifications and substitutions do not cause the corresponding technical features to depart in substance from the spirit and scope of the technical solutions of various embodiments of the present disclosure.

What is claimed is:

1. A method for mobile terminal upgrading, comprising:
at an electronic device;
triggering to close a CPU upon application upgrade on a mobile terminal;
maintaining a desktop system and triggering to close an application icon on the desktop system during restart of the CPU; and
reloading the application icon to the desktop system upon restart of the CPU.

2. The method according to claim 1, further comprising:
pre-setting a desktop kill command, the desktop kill command being used for causing the application icon on the desktop system to disappear.

3. The method according to claim 2, wherein the desktop kill command is to open any APK on the desktop system.

4. The method according to claim 2, wherein the desktop kill command is to open a designated APK on the desktop system.

5. The method according to claim 3, wherein the maintaining a desktop system and triggering to close an application icon on the desktop system during restart of the CPU comprises:
maintaining the desktop system and causing the application icon on the desktop system to disappear by opening any APK or a designated APK on the desktop system.

6. An electronic device, comprising:
at least one processor; and
a memory communicably connected with the at least one processor for storing instructions executable by the at least one processor, wherein execution of the instructions by the at least one processor causes the at least one processor to:
trigger to close a CPU upon application upgrade on a mobile terminal;
maintain a desktop system and trigger to close an application icon on the desktop system during restart of the CPU; and
reload the application icon to the desktop system upon restart of the CPU.

7. The electronic device according to claim 6, further comprising:
pre-setting a desktop kill command, the desktop kill command being used for causing the application icon on the desktop system to disappear.

8. The electronic device according to claim 7, wherein the desktop kill command is to open any APK on the desktop system.

9. The electronic device according to claim 7, wherein the desktop kill command is to open a designated APK on the desktop system.

10. The electronic device according to claim 8, wherein maintain a desktop system and trigger to close an application icon on the desktop system during restart of the CPU comprises:
maintaining the desktop system and cause the application icon on the desktop system to disappear by opening any APK or a designated APK on the desktop system.

11. A non-transitory computer-readable storage medium storing executable instructions that, when executed by an electronic device with a touch-sensitive display, cause the electronic device to:
trigger to close a CPU upon application upgrade on a mobile terminal;
maintain a desktop system and triggering to close an application icon on the desktop system during restart of the CPU; and
reload the application icon to the desktop system upon restart of the CPU.
